(19) United States
(12) Patent Application Publication
(10) Pub. No.: US 2002/0015087 A1
(43) Pub. Date: Feb. 7, 2002

(54) THERMAL HEAD AND TEMPERATURE CONTROL APPARATUS FOR PRINTER

(75) Inventors: HIROSHI ORITA, SAITAMA (JP); MINORU SUZUKI, TOCHIGI (JP); MIKIO HORIE, SAITAMA (JP); TAKEMI IWAYAMA, KANAGAWA (JP); MASAHIKO SASAKI, CHIBA (JP); KATSUYOSHI SUZUKI, TOKYO (JP)

Correspondence Address: GREENBLUM & BERNSTEIN, P.L.C., 1941 ROLAND CLARKE PLACE, RESTON, VA, 20191, US

(73) Assignee: ASAHI KOGAKU KOGYO KABUSHIKI KAISHA, Tokyo (JP)

(21) Appl. No.: 09/263,259

(22) Filed: Mar. 5, 1999

(30) Foreign Application Priority Data
Mar. 6, 1998 (JP) P10-073145

(51) Int. Cl. B41J 2/36

(52) U.S. Cl. 347/191

(57) ABSTRACT

A thermal head for a printer includes a heating resistor temperature which is controlled by a temperature control apparatus. The temperature control apparatus senses the temperature of the heating resistor from a current flowing through the heating resistor and a temperature coefficient of the resistor. The temperature control apparatus includes a down-counter for decreasing an initial data corresponding to a current of the heating element when the heating element has a positive temperature coefficient. While, the temperature control apparatus includes an up-counter for increasing an initial data corresponding to a current of the heating element up to a full-count data when the heating element has a negative temperature coefficient.

### BACKGROUND OF THE INVENTION

1. Field of the Invention

The present invention relates to a thermal head and to a temperature control apparatus for controlling a heating temperature of the thermal head utilized in a recording apparatus, such as printer.

2. Description of the Related Art

In a printer for exhibiting pixels by a thermal head having one or more heating elements, it is necessary to control a heating temperature of the heating elements through a time controlled application of the electric current. Usually, the heating temperature is measured by a thermistor or another type of temperature sensor. However, due to a small-size of the printer the direct measurement is difficult as the heating elements are extremely small. In this case, the temperature of the heating element is predicted from a resistance of a thermistor disposed adjacent to the heating element within the thermal head.

Due to the temperature not being directly measured, the heating temperature is inaccurate, and the printing quality of the printer, using the thermal head, is thus limited.

### SUMMARY OF THE INVENTION

Therefore, an object of the present invention is to provide a thermal head capable of providing a highly accurate heating temperature.

Another object of the present invention is to provide a temperature control apparatus for controlling the heating temperature of the thermal head when utilized in a recording apparatus.

A thermal head according to the present invention comprises a heating resistor heated by a current to a temperature, the heating resistor having a temperature coefficient. A temperature control apparatus is also included that controls the temperature of the heating resistor. The temperature control apparatus comprises a sensing unit that senses a signal indicative of a current flowing in the heating resistor and a temperature control unit that controls the temperature according to the current sensed by the sensing unit.

A temperature control apparatus according to the present invention comprises a sensing circuit that senses a current flowing in the heating resistor and outputs a data indicative of the temperature and a temperature control circuit that controls a heating time of the heating resistor according to the current sensed by the sensing circuit.

### BRIEF DESCRIPTION OF THE DRAWINGS

The present invention will be better understood from the description of the preferred embodiments of the invention set fourth below together with the accompanying drawings, in which:

FIG. 1 is a cross-sectioned elevational view showing a high-resolution color printer including a temperature control apparatus for recording an image of an embodiment of the present invention;

FIG. 2 is an enlarged cross-sectioned elevational view showing an ink transfer unit of the embodiment;

FIG. 3 is an enlarged perspective partially-exploded view showing a yellow-ink container, a thermal head and a porous film;

FIG. 4 is an enlarged cross-sectional view showing the yellow-ink container, the thermal head and the porous film;

FIG. 5 is a cross-sectioned elevational view showing an ink transfer unit, excluding a platen roller, with ink not heated;

FIG. 6 is a cross-sectioned elevational view similar to FIG. 5 with the ink heated;

FIG. 7 is a block diagram showing a driver apparatus and peripheral circuit;

FIG. 8 is a block diagram showing a temperature control apparatus connected to a heating resistor;

FIG. 9 is a diagram showing a characteristic relationship between temperature and resistance of the heating resistor; and

FIG. 10 is a timing chart showing an operation of the driver apparatus.

### DESCRIPTION OF THE PREFERRED EMBODIMENTS

Hereinafter, the preferred embodiments of the present invention are described with reference to the attached drawings.

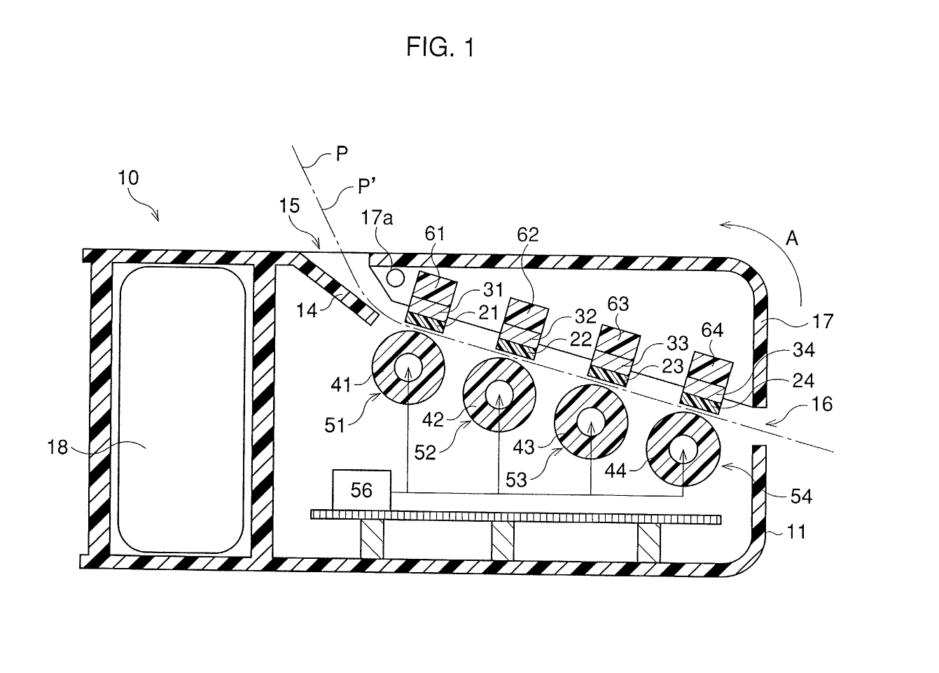

FIG. 1 is a cross-sectioned elevational view of a high-resolution color printer 10 for recording a full-color image on a recording sheet P.

The color printer 10 is a line printer comprising a housing 11, which is rectangular parallelepiped in a longitudinal direction (“line direction”, hereinafter) being perpendicular to a longitudinal direction of the recording sheet P, and four ink transfer units 51, 52, 53 and 54. An inlet slit 15 is provided on an upper surface of the housing 11 for inserting the recording sheet P, which is a normal sheet of plain paper, and an outlet slit 16 is provided in a right side surface of the housing 11. The recording sheet P passes along a conveyer path P′, shown by a single-chained line, from the insert slit 15 to the outlet slit 16.

The ink transfer units 51, 52, 53 and 54 correspond to colors yellow (Y), magenta (M), cyan (C) and black (BK), respectively. The ink transfer units 51, 52, 53 and 54 comprise ink containers 61, 62, 63 and 64, thermal heads 31, 32, 33 and 34 having respective heating elements, porous films 21, 22,23 and 24, and platen rollers 41, 42, 43 and 44, respectively.

The ink containers 61, 62, 63 and 64, the thermal heads 31, 32, 33 and 34, and the porous films 21, 22,23 and 24 are positioned over the conveyer path P′, fixed on and supported by a swing cover 17, which forms an upper-right corner of the housing 11. The swing cover 17 is rotatable in an anti-clockwise direction A around an axis of a support pin 17a supporting a left end of the swing cover 17.

The platen rollers 41, 42, 43 and 44 are made of rubber and are rotatably supported under the conveyer path P′. The platen rollers 41, 42, 43 and 44 are positioned to correspond to a set of the ink container 61, the thermal head 31 and the Porous film 21; a set of the ink container 62, the thermal head 32 and the porous film 22; a set of the ink container 63, the thermal head 33 and the porous film 23; and a set of the ink container 64, the thermal head 34 and the porous film 24, respectively.

The recording sheet P is introduced to the inlet slit 15, and is lead by a guide plate 14 to a nip between the first (Y) thermal head 31 and the corresponding first (Y) platen roller 41. Once taken up, the recording sheet P is conveyed along the conveyer path P′ to nips between the second (M) thermal head 32 and second (M) platen roller 42, the third (C) thermal head 33 and third (C) platen roller 43, and the fourth (BK) thermal head 34 and fourth (BK) platen roller 44, respectively. The transportation of the recording sheet P downstream toward the outlet slit 16 occurs due frictional forces generated by the thermal heads 31, 32, 33 and 34 pressing the recording sheet P on to the respective platen rollers 41, 42, 43 and 44, and by the platen rollers 41, 42, 43 and 44 then being driven by a motor 56. Each platen roller 41, 42, 43 and 44 is driven at a constant speed, with the speed at which each subsequent platen roller 41, 42, 43 and 44 is driven at slightly increasing over the previous platen roller 41, 42, 43 and 44. Namely, platen roller 42 has a slightly higher constant rotational velocity than platen roller 41; platen roller 43 has a slightly higher constant rotational velocity than platen roller 42; and platen roller 44 has a slightly higher constant rotational velocity than platen roller 43, thereby ensuring positive tensioned transportation of the recording sheet P downstream.

A battery 18 for supplying electric power to the components of the color printer 10, such as the motor 56 and control circuits, is disposed in a compartment of the housing 11 at a side opposite to the surface with the outlet slit 16.

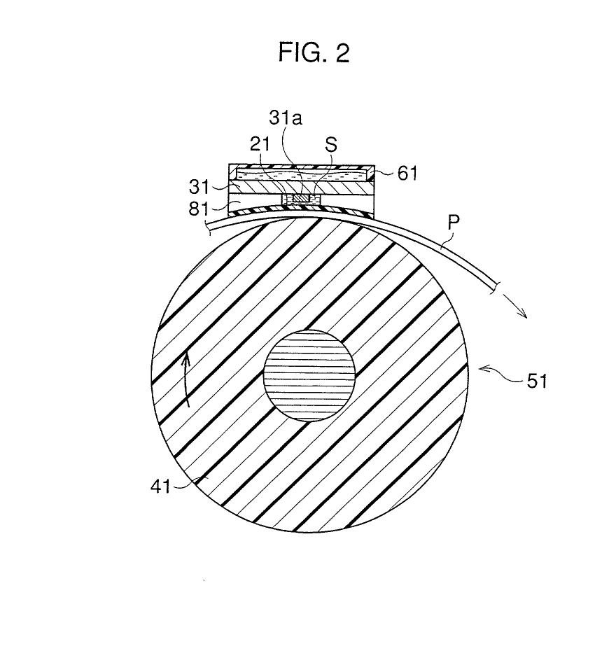

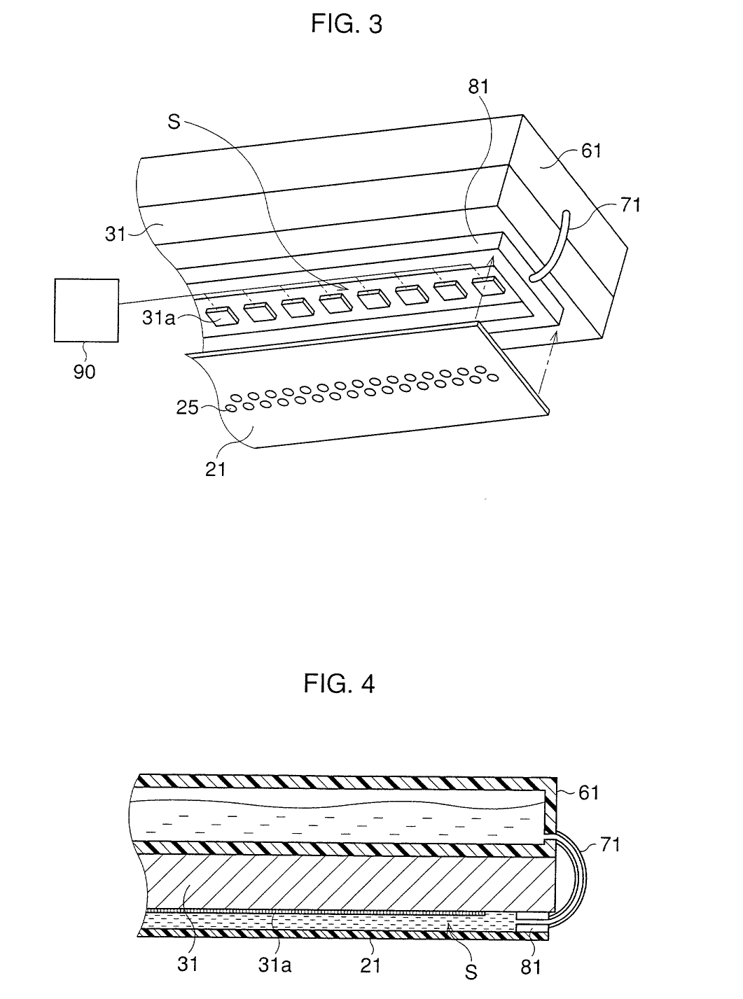

A detailed description of the ink transfer units 51 to 54 now follows with reference to FIGS. 2 to 4. FIG. 2 is an enlarged cross-sectioned elevational view showing the ink transfer unit 51 for the yellow ink. FIG. 3 is an enlarged perspective partially-exploded view showing the yellow-ink container 61, the Y thermal head 31 and the porous film 21. FIG. 4 is an enlarged cross-sectioned view showing the yellow-ink container 61, the Y thermal head 31 and the porous film 21.

In FIGS. 2 and 3, the Y thermal head 31 is disposed under the ink container 61 and is provided with a plurality of heating elements 31a on a bottom surface of the Y thermal head 31, aligned along the line direction and corresponding to pixels of one line. The heating elements 31a are, for example, resistors made of a barium-titanate-based ceramic having a positive temperature coefficient of resistivity. The heating elements 31a are heated and controlled by a driver apparatus 90, which is controlled by a controller (not shown) in the printer 10.

The porous film 21, comprising a plurality of fine pores 25, is adhered to the bottom surface of the Y thermal head 31 over a spacer 81. Since the manufacture of the porous film 21 is well-known, it is not detailed herein. The porous film 21 is positioned adjacent to the heating elements 31a so that the porous film 21 contacts or is in extremely close proximity to the heating elements 31a. The spacer 81 is a thin frame surrounding the alignment of the heating elements 31a so that the heating elements 31a are accommodated within an ink space S generated by the thermal head 31, the porous film 21 and the spacer 81. The Y ink is held in the space S. The spacer 81 is formed of a suitable non-porous material and is adhered to the Y thermal head 31.

As shown in FIG. 4, the ink space S and the ink container 61 are interconnected via a pipe 71 at the longitudinal ends thereof, a right-end side is only shown in FIGS. 3 and 4, but a similar arrangement also occurs at an opposite left-end side. The ink space S is thus continually charged with the yellow ink (Y) stored within the ink container 61. When the recording sheet P is interposed between Y thermal head 31 and Y platen roller 41, the porous film 21 resiliently contacts a recording surface of the recording sheet P.

The ink transfer units 52, 53 and 54, corresponding to M, C and BK, are similar in construction to the ink transfer unit 51 with M heating elements, C heating elements and BK heating elements, respectively, thus further descriptions are omitted. The number of ink transfer units and the platen rollers are determined in response to the number of colored ink utilized, and may be more or less than the four presented herein.

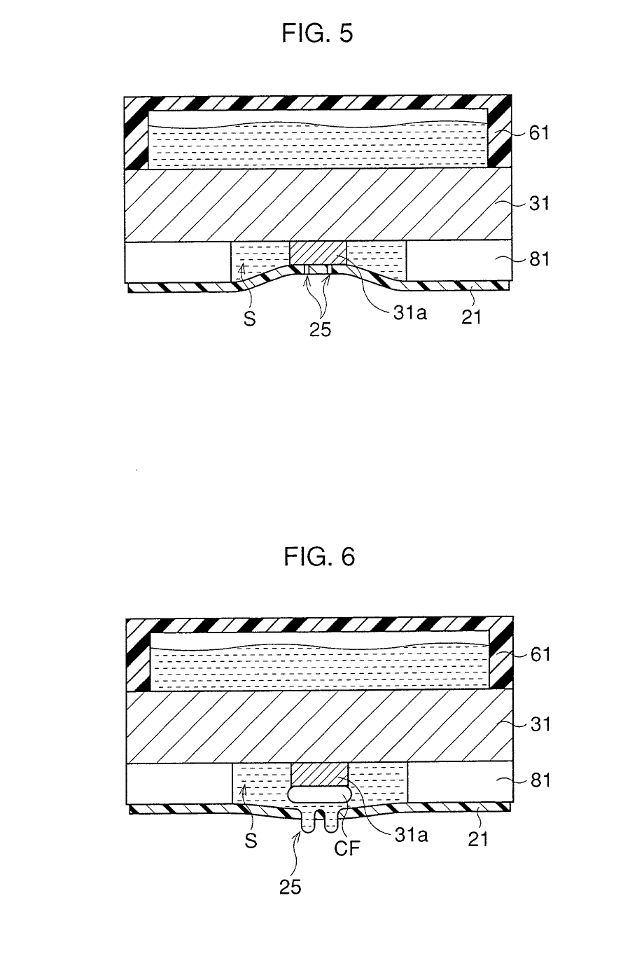

The porous film 21 is, for example, a porous resin made of polytetrafluoroethylene (well-known as the trademark “Teflon”) with a diameter of the fine pores 25 being small enough to prevent the liquid ink (Y, M, C, BK) and vapor of a solvent thereof from penetrating and permeating through from the ink space S filled with the ink at normal ambient room pressure and temperature, when the heating element 31a is not heated, as shown in FIG. 5.

When the Y heating element 31a is heated (FIG. 6), the Y ink and the porous film 21 adjacent to the heating element 31a is heated. The ink vaporizes and expands, generating a vapor cavity CF. The pores 25 in the region of the heated Y ink easily enlarge, due to the lowering of the elasticity of the porous film 21 in the heated Y ink region. As the ink expands, a high local ink pressure from the vapor cavity CF occurs, forcing the Y ink into the pores 25, thus enlarging the pores 25 further. Therefore, the Y ink penetrates and permeates through the pores 25 of the porous film 21 and is transferred to the recording surface of the recording sheet P that is pressed by the platen roller 41 against the thermal head 31. After the Y ink transfer, the selective heating of the heating elements 31a is stopped, and the heated ink and the heated porous film are cooled by convection and conduction. The enlarged pores 25 return to the original sizes, through which the liquid ink and associated vapor cannot permeate.

The color printer 10 utilizing the ink transfer units 51 to 54 generates any full-color image on the recording sheet P by selectively heating the respective Y, M, C and BK heating elements. The inks (Y, M, C and BK) are thus selectively transferred to the recording surface of the recording sheet P.

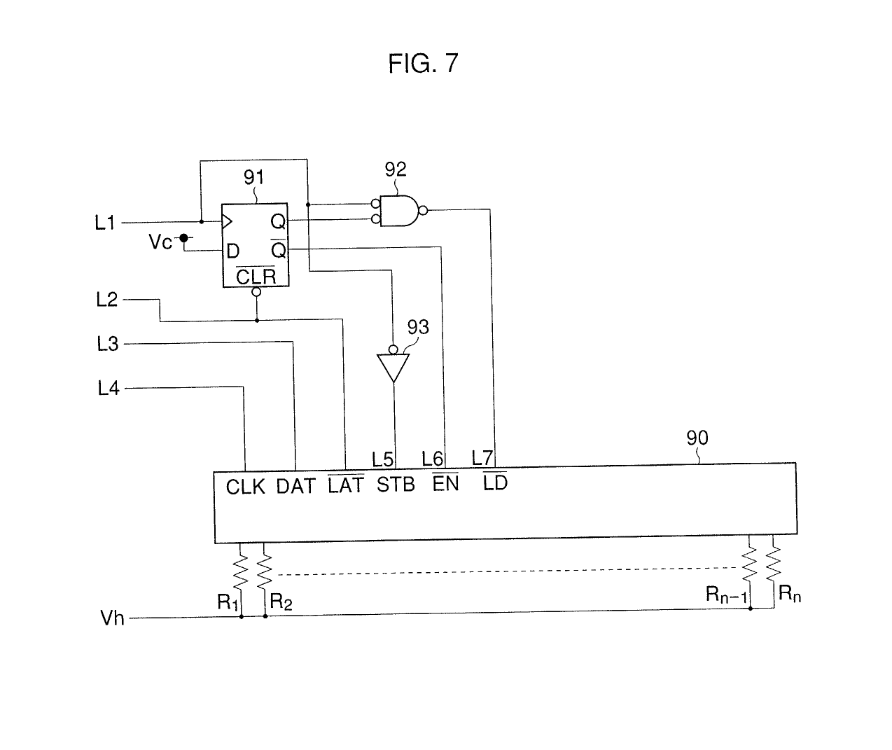

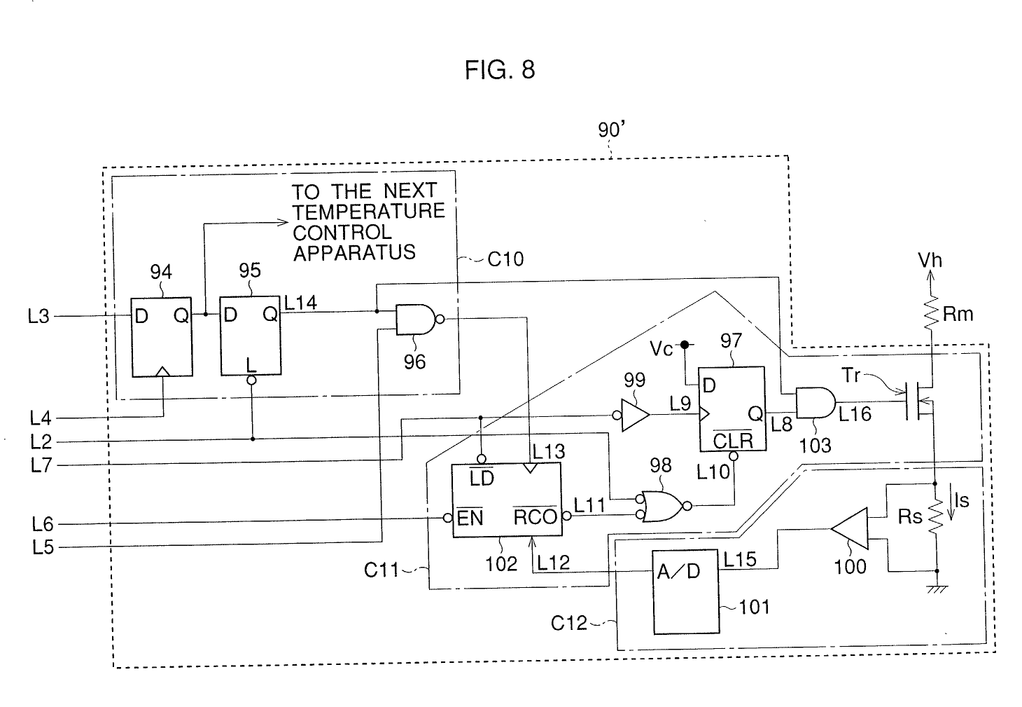

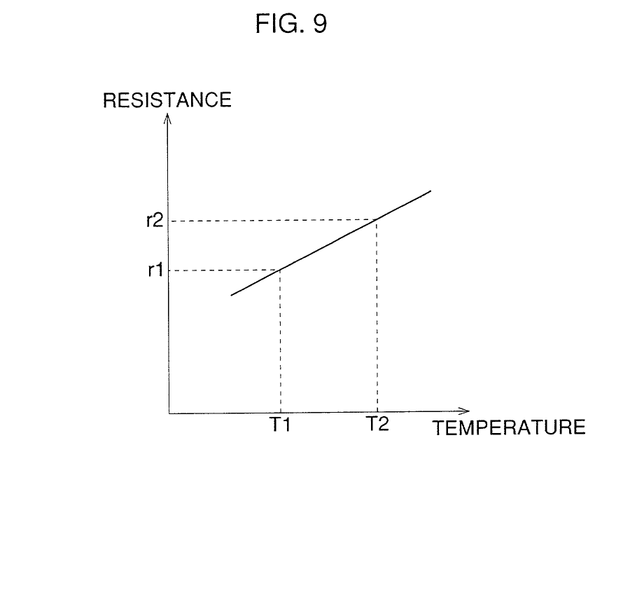

The temperature control apparatus used in the driver apparatus 90 is now described in detail with reference to FIGS. 7 to 9. FIG. 7 is a block diagram showing a driver apparatus connected to a control circuit, FIG. 8 is a block diagram showing a temperature control apparatus connected to an m^{th} heating resistor Rm among the heating resistors R1 to Rn in FIG. 7, and FIG. 9 is a diagram showing an example of a characteristic relationship between temperature and resistance of the heating resistors R1 to Rn.

The heating resistors R1 to Rn correspond to the heating elements (31a in FIG. 3, for example), which in turn correspond to a number of pixels on one line printed by the printer 10. Therefore, “n” represents a number of heating resistors R1 to Rn, a number of Y heating elements 31a, M heating elements, C heating elements, BK heating elements, and a number of pixels printed per printing line. The heating resistors R1 to Rn have a characteristic relationship between temperature and resistance. The temperature coefficient is positive in FIG. 9, that is, a resistance “r” of the heating resistors R1 to Rn increases as a temperature “T” of the heating resistors R1 to Rn rises. The temperature of the thermal head 31 is raised by heating for a predetermined heating time.

The driver apparatus 90 is connected in parallel to the heating resistors R1 to Rn to perform heating, and is controlled by a controller (not shown) incorporated within the printer 10. The driver apparatus 90 directly receives control signals L2 to L4, at terminals \overline{LAT}, DAT and CLK, respectively. The signal L3 is a digital image-pixel signal of one line of an image to be printed. The signal L2 is a latch signal for receiving the data signal L3 at a proper timing. The signal L4 is a data-extracting signal synchronous to the signal L2, which extracts heating element data signal L3 for each Y, M, C and BK heating element. A control signal L1 is input to the driver apparatus 90 for setting up the heating resistors R1 to Rn for the Y, M, C and BK heating elements, and for driving timers which determine the heating time of the heating resistors R1 and Rn. The signal L1 is input to the driver apparatus 90 through a D-flip-flop 91 and logic gates 92 and 93. The logic gate 92 is an inverted-input type NAND-gate (OR-gate) and the logic gate 93 is a NOT-gate. The signal L1 is input to a data input of the D-flip-flop 91 as well as to the logic gates 92 and 93. The inverted-input type NAND-gate 92 further receives a non-inverted data output Q of the D-flip-flop 91. An output of the inverted-input type NAND-gate 92 is input to the driver apparatus 90 as a control signal L7 at a terminal LD, which is a load signal for loading an initial value of the timer corresponding to the ink-transfer unit 51, 52, 53 or 54 to be initially activated. An output of the NOT-gate 93 is input as a control signal L5 at a terminal STB, which is a clock signal for the corresponding timer. An inverted data output from \overline{Q} of the D-flip-flop 91 is input as a control signal L6 at a terminal \overline{EN}, which is an enable signal of the timer.

The driver apparatus 90 includes “n” number of temperature control apparatuses 90′ (FIG. 8) independent from one another, corresponding to each heating resistor R1 to Rn.

FIG. 8 shows the temperature control apparatus 90′ for an m-th heating resistor Rm, being a resistor between R1 and Rn. The heating resistor Rm has opposite terminals, one of which is connected to a power supply of a constant direct voltage Vh, and the other of which is connected to the temperature control apparatus 90′.

The temperature control apparatus 90′ includes a current sensor 100, which is connected to the heating resistor Rm through a sensing resistor Rs and a switching device Tr. The current sensor 100 is a differential amplifier, for example. The switching device Tr is an nMOS, for example, having a drain and a source connected to the resistors Rm and Rs, respectively. When the switching device Tr is closed, a current through the heating resistor Rm is introduced to the sensing resistor Rs, causing a voltage drop between opposite terminals of the sensing resistor Rs. The current sensor 100 outputs an analog signal L15 corresponding to this voltage drop. This analog signal L15 is input to an analog-to-digital converter 101 and is converted to a digital signal L12 representing an initial value X of a down-counter 102, which is the “timer” for determining the duration of heating of the heating resistor Rm. A sensing circuit C12 incorporates the sensing resistor Rs, the current sensor 100 and the analog-to-digital converter 101.

The control signals L3 and L4 are input to a data input D and a clock input of a D-flip-flop 94, which extracts data dm from the total data for the total resistors R1 to Rn, indicating that the heating is to be performed by the resistor Rm. The extracted data dm is held by a D-flip-flop 95 connected at its data input D to a data output Q of the D-flip-flop 94. The output from the data output Q of the D-flip-flop 94 is also transferred to the next temperature control circuit of the resistor Rm+1. An output L14 of D-flip-flop 95 is input to a NAND-gate 96, which receives the signal L5, being inverted signal L1. An output of the NAND-gate 96 is input to the down-counter 102 as a clock signal L13 for step-wisely driving the down-counter 102. A clock-signal-generating circuit C10 is thus constructed from the D-flip-flops 94 and 95, and the NAND-gate 96.

An output L11 from \overline{RCO} of the down-counter 102 is input to an inverted-input type NOR-gate (AND-gate) 98, an output L10 of which is input to a clear terminal CLR of a D-flip-flop 97. Both a high voltage Vc is input to a data input D of the D-flip-flop 97, and clock signal L9, being inverted load signal L7 by NOT-gate 99, is input to a clock input of the D-flip-flop 97. The D-flip-flop 97 holds and outputs the high voltage Vc when the clock signal L9 changes from a low level to a high level while the clear input L10 is at a high level. After passing through an AND-gate 103, an output L8 of the D-flip-flop 97 is input as a signal L16 to the switching device Tr, which is connected between the heating resistor Rm and the sensing resistor Rs. The heating resistor Rm is connected to a high voltage Vh and the sensing resistor Rs is grounded. When the switching device Tr is closed, the current Is flows through the heating resistor Rm and the sensing resistor Rs so that the heating resistor Rm generates heat and the current sensor 100 detects the current Is. The latch signal L2 is also input to the inverted-input type NOR-gate 98 so that the switching device Tr is closed after the loading of the initial data L7 into the down-counter 102. The extracting signal L14 is also input to the AND-gate 103 so that the switching device Tr is closed after the down-counter 102 starts counting. A temperature control circuit C11 is thus constructed from the down-counter 102, the AND-gates 98 and 103, the NOT-gate 99, the D-flip-flop 97 and the switching device Tr.

The control signals are summarized in the following Table 1.

TABLE 1
Control Signal Designation

| Signal | |
|---|---|
| Name | Designation |
| L1 | Heating Resistor Set-up Signal |
| L2 | Latch Signal for Extracting Data |
| L3 | Image Data Signal |
| L4 | Data Extracting Signal for Temperature Control |
| | Apparatus |
| L5 | Inversion of Signal L1 |
| L6 | Inversion of Signal L1 After D-F-F |
| L7 | Load Signal |
| L8 | Latched Signal for Switching Device |
| L9 | Inversion of Signal L7 |
| L10 | L2 × L11 / Clear Signal for Signal L8 |
| L11 | Output of Timer (Down-counter) |
| L12 | Temperature Sensor Output (Digital) |
| L13 | Load Signal of Timer |
| L14 | Second Stage Latch Signal of Signal L3 |
| L15 | Temperature Sensor Output (Analog) |
| L16 | L8 × L14 / Switch Control Signal |

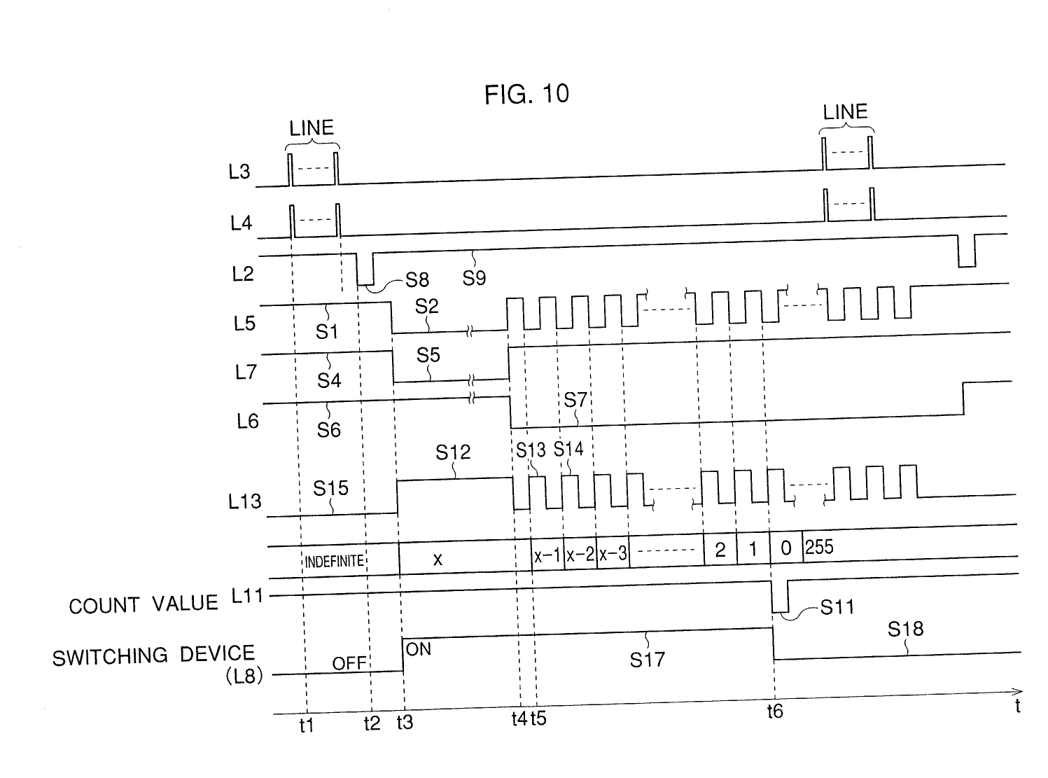

An operation of the temperature control apparatus 90′ is described with reference to a timing chart in FIG. 10.

At time “t1”, the digital image-pixel signal L3 of one pixel line and the data extracting signal L4 are input to the D-flip-flop 94 of the temperature control apparatus 90′. The D-flip-flop 94 extracts the data dm indicating whether the heating resistor Rm is to be heated. The extracted data dm is held by the D-latch 95. When the latch signal L2 becomes low for a short time, as shown by reference S8, at time “t2”, the data-extracting signal L14 is kept high. The signal L2 returns to a high level, as shown by “S9”, and, at this time, since the timer load signal L13 output from the NAND-gate (96) is kept low (S15), the down-counter 102 does not count.

At time “t3”, the set-up signal L1 becomes high, and the signals L7 and L5 generated by the signal L1 become low (S2 and S5, respectively). When the load signal L7 changes from a high level (S4) to a low level (S5), the inverted-level clock signal L9, generated by the inverter 99, becomes high. The signal L5 changes from a high level (S1) to a low level (S2) at a predetermined frequency. Then, the D-flip-flop 97 holds and outputs the voltage Vc. The switching device Tr is closed (S17) at time t3 by the output L16 when the AND-gate 103 receives the signals L8 (Vc) and the signal L14 (dm). Thus, at time t3, the heating resistor Rm starts to be heated by current Is.

While, the initial data L12 (X) is loaded to the down-counter 102, at time “t3”, by the load signal L7, which changes from a high level to a low level, the load signal L7 is kept at a low level (S5) until time “t4”, being a suitable period to allow the heating resistor Rm stabilize. Similarly, the enable signal L6 is kept at a high level (S6) disabling the down-counter 102 while initial data L12 (X) is loaded until t4. At t4, signal L6 becomes low (S7) enabling the down-counter 102.

Inverted signal L5, i.e. signal L1, and load signal L7 are changed to a continuous series of pulses at time “t4”, and consequently the clock signal L13, which follows the level changes of signal L1, becomes high (S12) during t3 to t4 as the initial data L12 (X) is being loaded, from being low (S15), and the pulses (S13, S14) during the operation of the down-counter 102. L7 does not pulse after t4. The down-counter 102 decrements the initial value X by one every level change of the signal L5, with a pulse frequency being a period between time t4 and t5 in FIG. 10. When the total initial data X reaches “0”, the down-counter 102 outputs signal L11 at a low level from \overline{RCO}, as an OR-logic output of the total bits of the count value. The down-counter 102 is, for example, an 8-bit counter with an integrated OR-logic-gate (not shown in FIG. 8). Thus, the output signal L10 of the inverted-input type NOR-gate 98 is changed to a low level, and the output of the D-flip-flop 97 is cleared. The switch control signal L16 output from the AND-gate 103, due to the output of the latch signal L8 from D-flip-flop 97, becomes low, and the switching device Tr is opened (S18) so that the heating is stopped at time t6.

The temperature of the heating resistor Rm can be measured from the current Is, flowing through the heating resistor Rm. Therefore, a more accurate control can be realized than that in the prior art.

The initial data X is adjusted by a gain of the current sensor 100, so that the relationship between the temperature and the current is optimized.

As shown in FIG. 9, the resistance of the heating resistor Rm increases from r1 to r2 when the temperature rises from T1 to T2. Then, the current Is flowing through the resistors Rm and Rs decreases. As a result, the initial data X corresponding to the heating time decreases.

When the temperature coefficient is positive, the higher the resistor Rm temperature of heating is, the less the amount of initial data X. When the temperature coefficient is negative, the higher the resistor Rm temperature of heating is, the greater the amount of initial data X. When the temperature coefficient is positive, the heating time can be measured by down-counting to zero the initial data.

When the temperature coefficient is negative, the heating time can be measured by up-counting the initial data X to a full-count, for example, hexadecimal FF. In this case, a NAND-logic output of the total bits of the full count data is used as the output \overline{RCO}, an integrated NAND-logic-gate replacing the aforementioned integrated OR-logic-gate.

Finally, it will be understood by those skilled in the art that the foregoing description is of preferred embodiments of the device, and that various changes and modifications may be made to the present invention without departing from the spirit and scope thereof. Naturally, the thermal head can be applied to any other recording apparatus, other than a printer.

The present disclosure relates to subject matters contained in Japanese Patent Application No.10-73145 (filed on Mar. 6, 1998) which is expressly incorporated herein, by reference, in its entirety.

1. A thermal head of a recording apparatus, comprising:
a heating resistor heated by a current to a temperature, said heating resistor having a temperature coefficient; and
a temperature control apparatus that controls said temperature of said heating resistor, said temperature control apparatus including:
a sensing unit that senses a signal indicative of a current flowing in said heating resistor; and
a temperature control unit that controls said temperature according to said current sensed by said sensing unit.

2. The thermal head of claim 1, wherein said heating resistor is disposed such that ink enclosed within an ink space is heated, a part of said ink space being defined by a porous member that said ink permeates when heated and pressured.

3. A temperature control apparatus that controls a temperature of a heating resistor of a thermal head disposed in a recording apparatus, comprising:
a sensing circuit that senses a current flowing in said heating resistor and outputs a data indicative of said temperature; and
a temperature control circuit that controls a heating time of said heating resistor according to said current sensed by said sensing circuit.

4. The temperature control apparatus of claim 3, wherein said sensing circuit further comprises a sensing resistor connected serially to said heating resistor, said sensing resistor having opposite terminals.

5. The temperature control apparatus of claim 4, wherein said sensing circuit further comprises a current sensor that amplifies a voltage between said opposite terminals of said sensing resistor, such that a relationship between said temperature and said data is adjustable.

6. The temperature control apparatus of claim 5, wherein said sensing circuit further comprises an analog to digital converter that converts said voltage amplified by said current sensor.

7. The temperature control apparatus of claim 3, wherein said temperature control circuit further comprises:
a switching unit that switchably connects said heating resistor to a power supply; and
a counter that counts a clock signal of a predetermined frequency to measure a heating time, said counter being loaded an initial data according to said current measured, said counter opening said switching unit when said counter reaches a predetermined value.

8. The temperature control apparatus of claim 7, wherein said counter is a down-counter that stepwisely decrements said initial data down to zero in response to said clock signal when said heating resistor has a positive temperature coefficient.

9. The temperature control apparatus of claim 7, wherein said counter is an up-counter that stepwisely increments said initial data up to a full count value of said counter in response to said clock signal when said heating resistor has a negative temperature coefficient.

10. The temperature control apparatus of claim 7, further comprising a clock-signal-generating circuit that generates said clock signal, said clock-signal-generating circuit being disposed such that said counter is stopped when unstable, and said heating resistor is operated when stable.
